(19) United States
(12) Patent Application Publication
(10) Pub. No.: US 2021/0180690 A1
(43) Pub. Date: Jun. 17, 2021

(54) SHIFT RANGE CONTROL DEVICE

(71) Applicant: DENSO CORPORATION, Kariya-city (JP)

(72) Inventors: Haruka MIYANO, Kariya-city (JP); Koji SAKAGUCHI, Kariya-city (JP)

(21) Appl. No.: 17/184,779

(22) Filed: Feb. 25, 2021

Related U.S. Application Data
(63) Continuation of application No. PCT/JP2019/032276, filed on Aug. 19, 2019.

(30) Foreign Application Priority Data
Aug. 27, 2018 (JP) 2018-158252

(51) Int. Cl. F16H 61/32; H02P 3/22

(52) U.S. Cl. CPC F16H 61/32; F16H 2061/326; H02P 3/22

(57) ABSTRACT

A shift range control device switches a shift range by controlling drive of a motor having a motor winding, and includes a drive circuit and a controller. The drive circuit having switching elements provided corresponding to each phase of the motor winding. The controller drives the motor by controlling an on/off operation of the switching elements, and stops the motor at a target stop position according to a target shift range. The controller turns off all the lower arm elements and turns on a predetermined number of upper arm elements in the stop control for stopping the motor at the target stop position so as to reflux a current between the motor winding and the drive circuit.

### CROSS REFERENCE TO RELATED APPLICATIONS

This application is a continuation application of International Patent Application No. PCT/JP2019/032276 filed on Aug. 19, 2019, which designated the U.S. and based on and claims the benefits of priority of Japanese Patent Application No. 2018-158252 filed on Aug. 27, 2018. The entire disclosure of all of the above applications is incorporated herein by reference.

### TECHNICAL FIELD

The present disclosure relates to a shift range control device.

### BACKGROUND

A motor control device for switching a shift range by controlling the drive of a motor has been known.

### SUMMARY

An object of the present disclosure is to provide a shift range control device capable of stopping a motor with high accuracy.

The shift range control device of the present disclosure switches the shift range by controlling the drive of a motor having a motor winding, and includes a drive circuit and a control unit. The drive circuit has switching elements provided corresponding to each phase of the motor winding. The control unit drives the motor by controlling the on/off operation of the switching element, and stops the motor at a target stop position according to a target shift range.

The switching element connected to a high potential side is referred to as an upper arm element, and the switching element connected to a low potential side of the upper arm element is referred to as a lower arm element. In a stop control for stopping the motor at the target stop position, the control unit turns off all the lower arm elements, and turns on a predetermined number of upper arm elements so as to reflux a current between the motor winding and the drive circuit. As a result, the motor can be stopped accurately.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view showing a shift-by-wire system according to a first embodiment;

FIG. 2 is a schematic configuration diagram showing the shift-by-wire system according to the first embodiment;

FIG. 3 is a schematic view showing a stator and a rotor according to the first embodiment;

FIG. 4 is a circuit diagram showing a motor winding and a drive circuit according to the first embodiment;

FIG. 5 is a time chart illustrating motor drive control according to the first embodiment;

FIG. 6 is a diagram illustrating an energization path during feedback control according to the first embodiment;

FIG. 7 is a diagram illustrating an energization path during stop control by two phase energization according to a reference example;

FIG. 8 is an explanatory diagram illustrating an energization path during stop control according to the first embodiment;

FIG. 9 is a flowchart illustrating the motor drive control process according to the first embodiment;

FIG. 10 is a time chart illustrating switching of the energizing phase during stop control according to the first embodiment; and

FIG. 11 is a flowchart illustrating the motor drive control process according to a second embodiment.

### DETAILED DESCRIPTION

In an assumable example, a motor control device for switching a shift range by controlling the drive of a motor has been known. A process for holding a target position stop is performed by two phase energization.

By the way, when a DC brushless motor is used as an actuator for switching the shift range, if the motor stop control is performed by two phase energization, the rotor may continue to vibrate due to an action and reaction of a magnet between a rotor and a stator. Therefore, when the power is turned off after the two phase energization, the rotor may not stop and may rotate unintentionally depending on a timing. An object of the present disclosure is to provide a shift range control device capable of stopping a motor with high accuracy.

The shift range control device of the present disclosure switches the shift range by controlling the drive of a motor having a motor winding, and includes a drive circuit and a control unit. The drive circuit has switching elements provided corresponding to each phase of the motor winding. The control unit drives the motor by controlling the on/off operation of the switching element, and stops the motor at a target stop position according to a target shift range.

The switching element connected to a high potential side is referred to as an upper arm element, and the switching element connected to a low potential side of the upper arm element is referred to as a lower arm element. In a stop control for stopping the motor at the target stop position, the control unit turns off all the lower arm elements, and turns on a predetermined number of upper arm elements so as to reflux a current between the motor winding and the drive circuit. As a result, the motor can be stopped accurately.

Hereinafter, a shift range control device according to the present disclosure will be described with reference to the drawings. Hereinafter, in a plurality of embodiments, a substantially equivalent configuration will be denoted by an identical reference, and explanation thereof will be omitted.

### First Embodiment

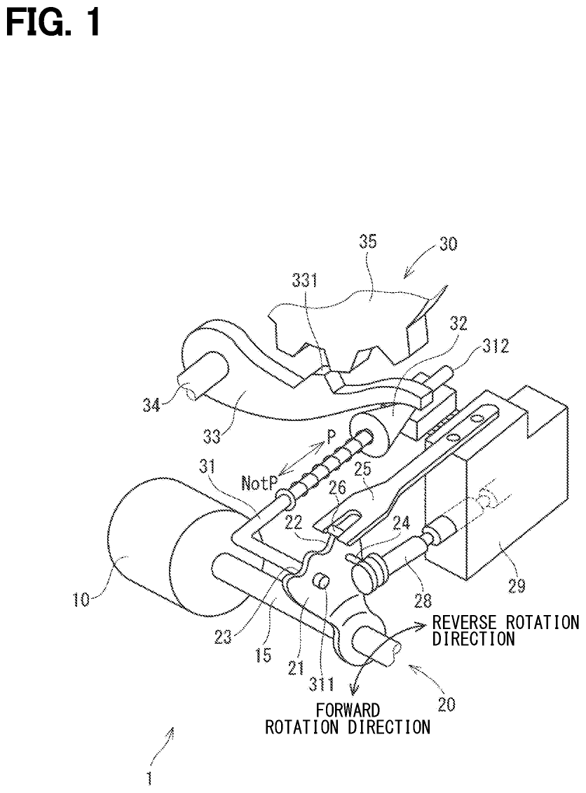

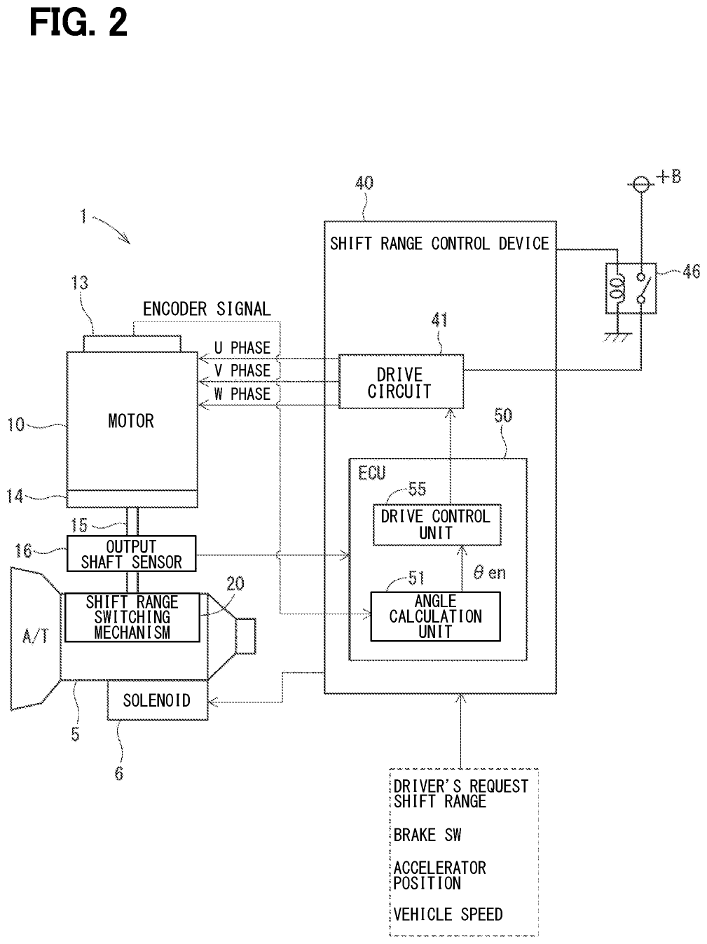

The first embodiment is shown in FIGS. 1 to 10. As shown in FIGS. 1 and 2, a shift-by-wire system 1 being a shift range switching system includes a motor 10, a shift range switching mechanism 20, a parking lock mechanism 30, a shift range control device 40, and the like.

The motor 10 rotates while receiving an electric power from a battery 45 mounted on a vehicle (not shown), and functions as a driving source of the shift range switching mechanism 20. The motor 10 of the present embodiment is a permanent magnet type DC brushless motor.

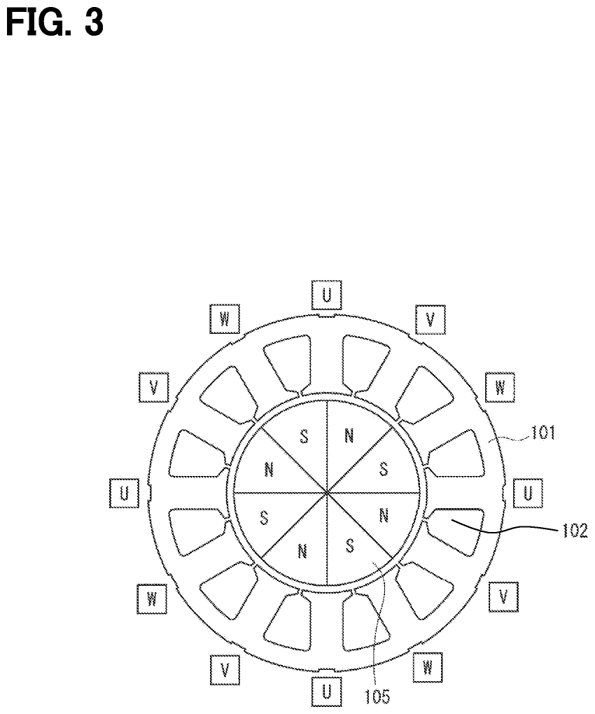

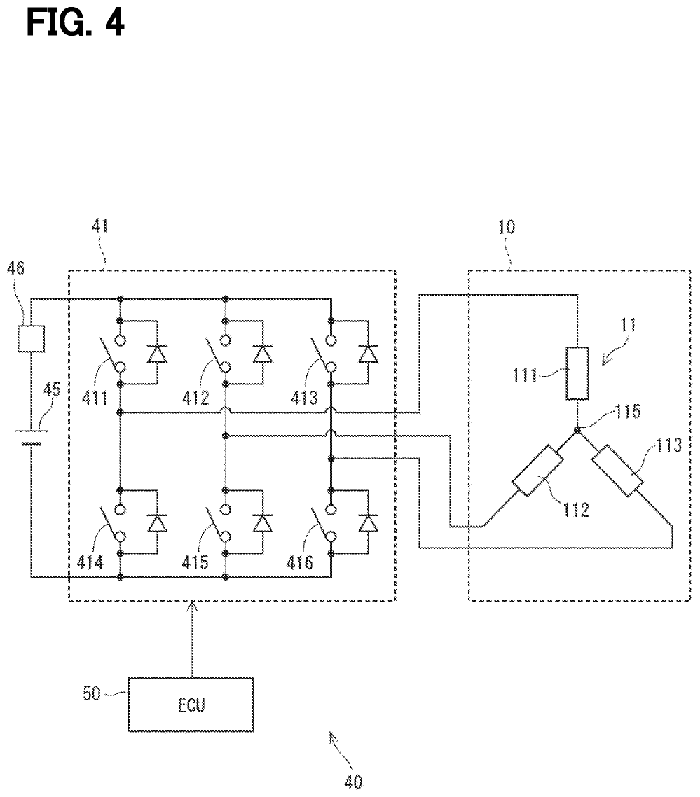

As shown in FIG. 3, the motor 10 has a stator 101, a rotor 105, and a motor winding 11 (see FIG. 4). The motor winding 11 has a U phase coil 111, a V phase coil 112, and a W phase coil 113. Slots 102 are formed in the stator 101. The number of slots in the present embodiment is twelve. The motor winding 11 is wound in the slot 102. The rotor 105 has a permanent magnet, and when the motor winding 11 is energized, the rotor 105 rotates integrally with a motor shaft (not shown). The number of magnetic poles of the rotor 105 is eight. The number of slots and the number of magnetic poles can be appropriately designed.

As shown in FIG. 2, an encoder 13 as a motor rotation angle sensor detects a rotation position of the rotor 105. The encoder 13 is, for example, a magnetic rotary encoder and is made up of a magnet that rotates integrally with the rotor, a magnetic detection hall integrated circuit (IC), and the like. The encoder 13 is a three-phase encoder that outputs an encoder signal which is an A phase, B phase, and C phase pulse signal at predetermined angles in synchronization with the rotation of the rotor.

A speed reducer 14 is provided between a motor shaft of the motor 10 and an output shaft 15 and outputs the rotation of the motor 10 to the output shaft 15 after speed reduction. The rotation of the motor 10 is thus transmitted to the shift range switching mechanism 20. An output shaft sensor 16 for detecting an angle of the output shaft 15 is provided on the output shaft 15. The output shaft sensor 16 of the present embodiment is, for example, a potentiometer.

As shown in FIG. 1, the shift range switching mechanism 20 includes a detent plate 21, a detent spring 25 and the like. The shift range switching mechanism 20 transmits the rotational drive force output from the speed reducer 14 to a manual valve 28 and the parking lock mechanism 30.

The detent plate 21 is fixed to the output shaft 15 and driven by the motor 10. In the present embodiment, a direction in which the detent plate 21 is separated from the base of the detent spring 25 is defined as a forward rotation direction, and a direction in which the detent plate 21 approaches the base is defined as a reverse rotation direction.

The detent plate 21 has a pin 24 protruding in parallel with the output shaft 15. The pin 24 is connected to a manual valve 28. The detent plate 21 is driven by the motor 10, whereby the manual valve 28 reciprocates in an axial direction. That is, the shift range switching mechanism 20 converts the rotational motion of the motor 10 into a linear motion and transmits the linear motion to the manual valve 28. The manual valve 28 is provided on a valve body 29. When the manual valve 28 moves back and forth in the axial direction to switch hydraulic pressure supply paths, which are lead to a hydraulic clutch (not shown), thereby to switch an engagement state of the hydraulic clutch. In this way, the shift range is switched.

Two recesses 22 and 23 are provided in the detent plate 21 on the detent spring 25 side. In the present embodiment, in the two recesses 22, 23, the side closer to the base of the detent spring 25 is the recess 22 and the side farther therefrom is the recess 23. In the present embodiment, the recess 22 corresponds to a not-P (NotP) range except for a P range, and the recess 23 corresponds to the P range.

The detent spring 25 is an elastically deformable plate-like member, and is provided with a detent roller 26 at a tip of the detent spring 25. The detent spring 25 biases the detent roller 26 toward a rotation center of the detent plate 21. When a rotational force equal to or greater than a predetermined force is applied to the detent plate 21, the detent spring 25 is elastically deformed, and the detent roller 26 moves between the recesses 22 and 23. When the detent roller 26 is fitted to any of the recesses 22 and 23, swing of the detent plate 21 is regulated. Accordingly, an axial position of the manual valve 28 and the state of the parking lock mechanism 30 are determined to fix the shift range of an automatic transmission 5. The detent roller 26 fits into the recess 22 when the shift range is the NotP range, and fits into the recess 23 when the shift range is the P range.

The parking lock mechanism 30 includes a parking rod 31, a conical member 32, a parking lock pawl 33, a shaft part 34 and a parking gear 35. The parking rod 31 is formed in a substantially L-shape. The parking rod 31 is fixed to the detent plate 21 on the side of one end 311. The conical member 32 is provided to the other end 312 of the parking rod 31. The conical member 32 is formed to reduce in diameter toward the other end 312. When the detent plate 21 pivots in the reverse rotation direction, the conical member 32 moves in a P direction.

The parking lock pawl 33 comes into contact with a conical surface of the conical member 32 and is provided so as to be swingable around the shaft part 34. On the parking gear 35 side of the parking lock pawl 33, a protrusion 331 that can mesh with the parking gear 35 is provided. When the detent plate 21 rotates in the reverse rotation direction and the conical member 32 moves in the direction of arrow P, the parking lock pawl 33 is pushed up, and the protrusion 331 meshes with the parking gear 35. On the other hand, when the detent plate 21 rotates in the forward rotational direction and the conical member 32 moves in a direction of an arrow non-P, the engagement between the protrusion 331 and the parking gear 35 is released.

The parking gear 35 is provided on an axle (not shown) and is enabled to mesh with the protrusion 331 of the parking lock pawl 33. When the parking gear 35 meshes with the protrusion 331, rotation of the axle is restricted. When the shift range is the NotP range, the parking gear 35 is not locked by the parking lock pawl 33 and the rotation of the axle is not restricted by the parking lock mechanism 30. When the shift range is the P range, the parking gear 35 is locked by the parking lock pawl 33 and the rotation of the axle is restricted.

As shown in FIGS. 2 and 4, the shift range control device 40 includes a drive circuit 41, an ECU 50, and the like. As shown in FIG. 4, the drive circuit 41 is a three-phase inverter that converts the electric power supplied from the battery 45, and includes switching elements 411 to 416 being bridge-connected. A relay 46 is provided between the battery 45 and the drive circuit 41.

The switching elements 411 and 414 are paired and belong to U phase. The switching elements 411 and 414 have a connection point therebetween, and the connection point is connected with one end of a U phase coil 111. The switching elements 412 and 415 are paired and belong to V phase. The switching elements 412 and 415 have a connection point therebetween, and the connection point is connected with one end of a V phase coil 112. The switching elements 413 and 416 are paired and belong to W phase. The switching elements 413 and 416 have a connection point therebetween, and the connection point is connected with one end of a W phase coil 113. The other ends of the coils 111 to 113 are connected to each other at a connection portion 115. While the switching elements 411 to 416 according to the present embodiment are MOSFETs, other devices such as IGBTs may also be employed. Hereinafter, the switching elements 411 to 413 connected to a high potential side will be referred to as “upper arm elements”, and the switching elements 414 to 416 connected to a low potential side will be referred to as “lower arm elements”.

As shown in FIG. 2, ECU 50 is mainly composed of a microcomputer and the like, and internally includes, although not shown in the figure, a CPU, a ROM, a RAM, an I/O, a bus line for connecting these components, and the like. Each process executed by the ECU 50 may be software processing or may be hardware processing. The software processing may be implemented by causing a CPU to execute a program. The program may be stored beforehand in a material memory device such as a ROM, that is, in a readable non-transitory tangible storage medium. The hardware processing may be implemented by a special purpose electronic circuit.

The ECU 50 controls the on/off operation of the switching elements 411 to 416, and controls a drive of the motor 10 so as to match the driver required shift range input by operating a shift lever or the like (not shown) with the shift range in the shift range switching mechanism 20. The ECU 50 performs a control to drive a transmission hydraulic control solenoid 6 based on a vehicle speed, an accelerator position, a shift range requested by a driver, and the like. The transmission hydraulic control solenoid 6 is controlled to manipulate a shift stage. The number of the transmission hydraulic control solenoid 6 is determined according to the shift stage or the like. According to the present embodiment, a singular ECU 50 performs the control to drive the motor 10 and the solenoid 6. It is noted that, the ECU may be divided into a motor ECU, which is for motor control to control the motor 10, and an AT-ECU, which is for solenoid control. Hereinafter, drive control of the motor 10 will be mainly described.

The ECU 50 has an angle calculation unit 51 and a drive control unit 55. The angle calculation unit 51 counts pulse edges of each phase of an encoder signal output from the encoder 13, and calculates an encoder count value θen. The encoder count value θen is a value corresponding to the rotation position of the motor 10 and corresponds to a “motor angle”.

The drive control unit 55 generates a drive signal related to drive control of the motor 10 so that the encoder count value θen is within a control range Rc including the target count value θcmd set according to the required shift range. The generated drive signal is output to the drive circuit 41. The drive of the motor 10 is controlled by switching the switching elements 411 to 416 on and off according to the drive signal. In the present embodiment, the target count value θcmd corresponds to the “target stop position”.

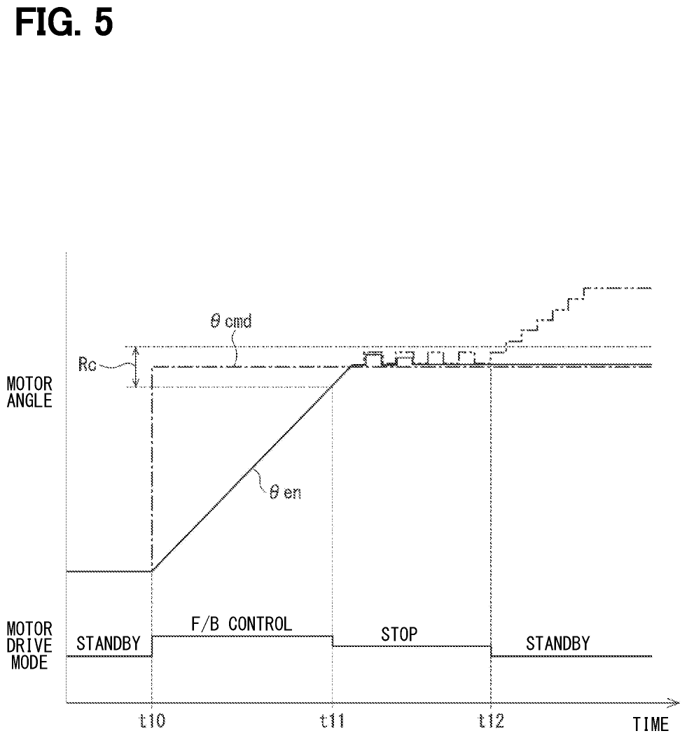

FIG. 5 is a time chart for explaining the drive control of the motor 10. In FIG. 5, a horizontal axis represents a common time axis, the motor angle is shown in the upper part, and the motor drive mode is shown in the lower part. Feedback is appropriately described as “F/B” in the figure. The motor angle is shown as a count value of the encoder 13, the target count value θcmd is shown by an alternate long and short dash line, and the encoder count value θen is shown by a solid line. For the sake of explanation, the lines are appropriately shifted. In addition, the time scale and the like are changed as appropriate, and the actual behavior does not always match. In FIG. 5, a case where the shift range is switched from the P range to the notP range will be described as an example.

When the required shift range is switched from the P range to the notP range at time t10, the motor drive mode is switched from a standby mode to a feedback control mode. Further, the motor 10 is driven so that the target count value θcmd is set and the encoder count value θen becomes the target count value θcmd.

When the encoder count value θen falls within the control range Rc including the target count value θcmd (for example, θcmd±2 counts) at time t11, the motor drive mode is switched from the feedback control mode to the stop control mode.

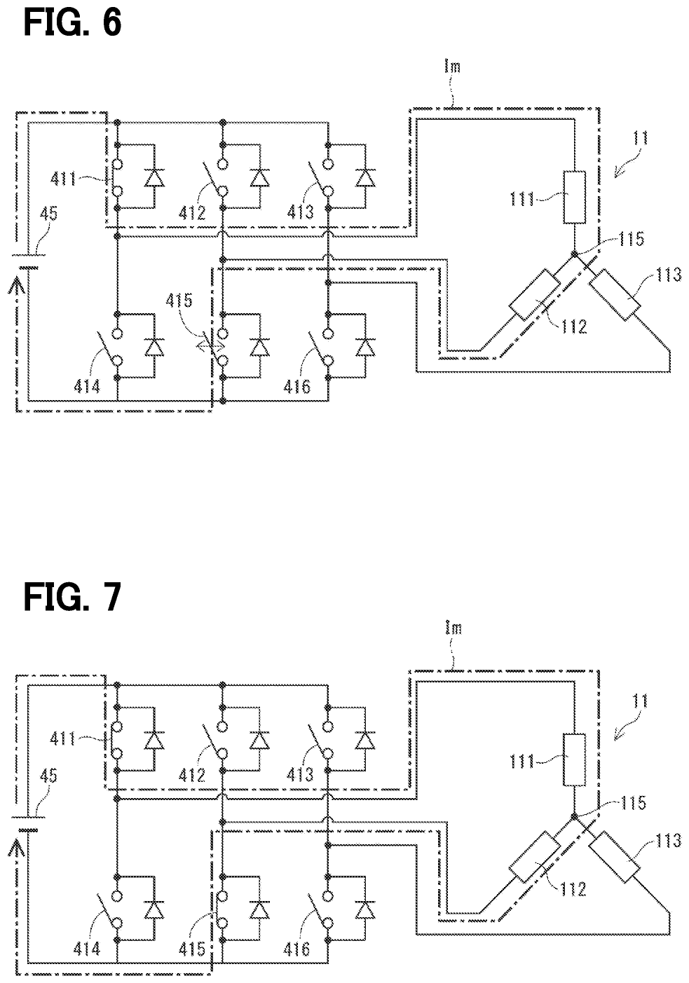

FIG. 6 shows an example of the energized state immediately before switching to the stop control. In FIGS. 6 to 8, the description of a part of the configuration of the relay 46 and the like is omitted, and an energization path is indicated by the arrow Im of the alternate long and short dash line. As shown in FIG. 6, the energization pattern immediately before switching to stop control is UV phase energization, and in the UV phase energization, the U phase upper arm element 411 is turned on and the V phase lower arm element 415 is turned on and off with a set duty.

Here, a reference example in which two phase energization is performed in stop control will be described. In two phase energization, for example, as shown in FIG. 7, the U phase upper arm element 411 and the V phase lower arm element 415 are turned on. As shown in FIG. 3, when the rotor 105 has a magnet and performs two phase energization, as shown by the alternate long and short dash line in FIG. 5, the rotor 105 may continue to vibrate due to the action and reaction of the magnet between the rotor 105 and the stator 101. If the energization is turned off at time t12 while the rotor 105 is vibrating, the rotor 105 will rotate depending on the timing of turning off, and in some cases, the output shaft 15 will be pushed up, and there is a risk of unintentionally switching to a range different from the target range. Although FIG. 5 shows an example of overshooting, undershooting may occur depending on the timing of turning off the power.

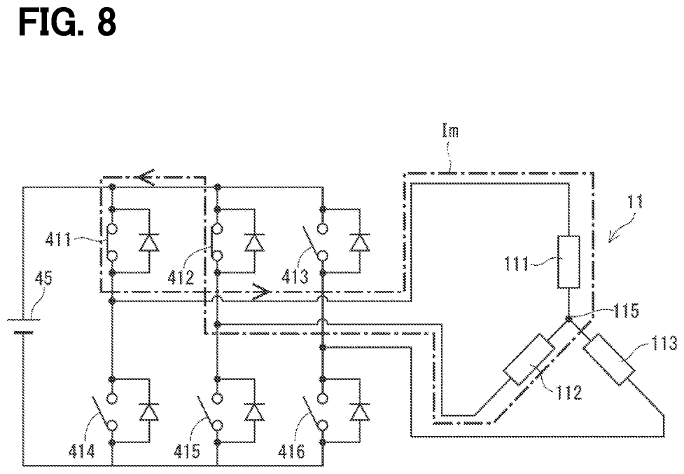

Therefore, in the present embodiment, as shown in FIG. 8, by turning on the upper arm elements 411 and 412 of the two phases (U phase and V phase in the example of FIG. 8), the current flowing through the motor winding 11 is refluxed. At this time, the current flows between the motor winding 11 and the drive circuit 41, and the current from the battery 45 is not used. By refluxing the current between the motor winding 11 and the drive circuit 41, the current is attenuated due to the resistance of the electronic components constituting the reflux path, and as shown by the solid line in FIG. 5, the vibration of the rotor 105 gradually subsides. Then, after the rotation speed N of the rotor 105 drops to a point where overshoot or undershoot does not occur even when the energization is turned off, all the switching elements 411 to 416 are turned off, and the motor 10 can be stopped within the control range Rc.

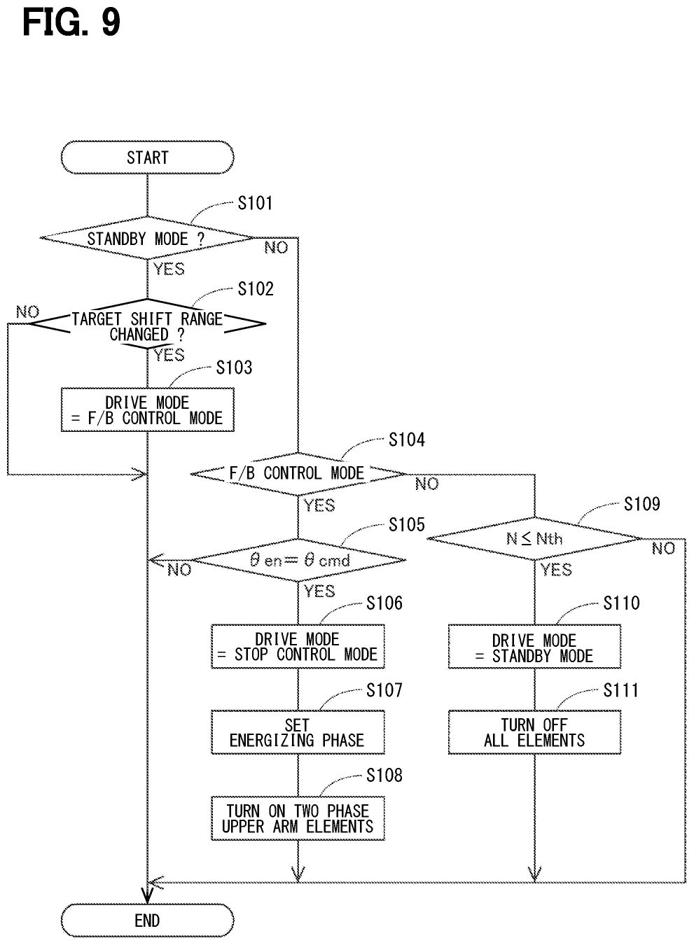

The motor drive control process of the present embodiment will be described with reference to the flowchart of FIG. 9. This process is executed by the ECU 50 at a predetermined cycle (for example, 1 [ms]). Hereinafter, “step” in step S101 is omitted, and is simply referred to as a symbol “5”. The same applies to the other steps.

In S101, the drive control unit 55 determines whether or not the motor drive mode is the standby mode. When it is determined that the drive mode is not the standby mode (S101: NO), the process proceeds to S104. When it is determined that the drive mode is the standby mode (S101: YES), the process proceeds to S102.

In S102, the drive control unit 55 determines whether the target shift range has been switched to another. If it is determined that the target range has not been switched (S102: NO), the process of S103 is not performed, the standby mode is maintained, and this routine is terminated. When it is determined that the target shift range has been switched to another (S102: YES), the process proceeds to S103, and the motor drive mode is switched to the feedback control mode.

In S104 which is transferred when a negative determination is made in S101, the drive control unit 55 determines whether or not the motor drive mode is the feedback control mode. If it is determined that the motor drive mode is not the feedback control mode (S104: NO), the process proceeds to S109. When it is determined that the motor drive mode is the feedback control mode (S104: YES), the process proceeds to S105.

In S105, the drive control unit 55 determines whether or not the encoder count value θen matches the target count value θcmd. Here, when the encoder count value θen is within a predetermined range including the target count value θcmd (for example, ±2 counts), it is considered that the encoder count value θen matches the target count value θcmd. When it is determined that the encoder count value θen does not match the target count value θcmd (S105: NO), the process after S106 is not performed, the feedback control mode is maintained, and this routine is terminated. When it is determined that the encoder count value θen matches the target count value θcmd (S105: YES), the process proceeds to S106.

In S106, the drive control unit 55 switches the motor drive mode to the stop control mode. In S107, the drive control unit 55 sets the energizing phase based on the encoder count value θen. In S108, the two phase upper arm elements determined in S107 are turned on. As a result, the motor current refluxes between the drive circuit 41 and the motor winding 11.

In S109, which is shifted when a negative determination is made in S104, that is, when the motor drive mode is the stop control mode, the drive control unit 55 determines whether or not the motor rotation speed N is equal to or less than a rotation speed determination threshold value Nth. The rotation speed determination threshold value Nth is set according to the rotation speed at which the rotor 105 can be stopped within the control range Rc when all the switching elements 411 to 416 are turned off. When it is determined that the motor rotation speed N is larger than the rotation speed determination threshold value Nth (S109: NO), the process after S110 is not performed, the stop control mode is continued, and this routine is terminated. When it is determined that the motor rotation speed N is equal to or less than the rotation speed determination threshold value Nth (S109: YES), the process shifts to S110, the motor drive mode is switched to the standby mode, and all switching elements 411 to 416 are turned off in S111.

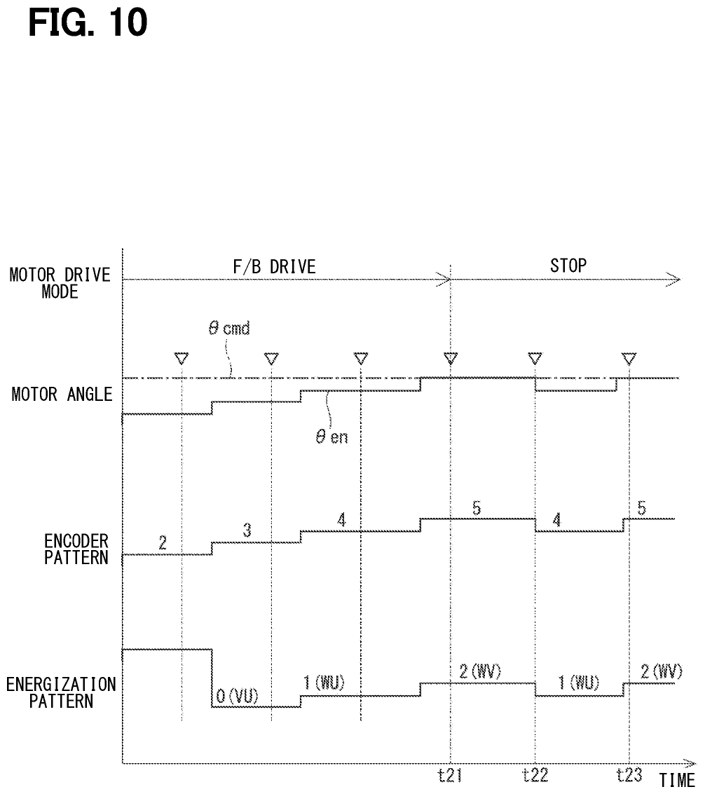

The process of S107 and S108 will be described with reference to FIG. 10. In FIG. 10, a horizontal axis represents a common time axis, the motor drive mode, the motor angle, the encoder pattern, and the energization pattern are shown from the upper part. In FIG. 10, when the encoder count value θen reaches the target count value θcmd, the F/B drive is switched to the stop control.

In the present embodiment, the encoder pattern is set to 0 to 6 according to the encoder count value θen. Then, the energization pattern is determined according to the set encoder pattern. The timing indicated by the white triangle is the execution timing of the motor drive control process of FIG. 9. The calculation of the encoder count value θen in the angle calculation unit 51 is interrupted every time the pulse edge of the encoder signal is detected.

The motor drive control mode is switched from the feedback control mode to the stop control mode at time t21, which is the first calculation timing after the encoder count value θen matches the target count value θcmd. Since the energization pattern at this time is WV phase energization, the V phase upper arm element 412 and the W phase upper arm element 413 are turned on.

Further, when the encoder count value θen changes at the time t22, which is the next calculation timing, due to the vibration of the rotor 105, the encoder pattern and the energization pattern change. Since the energization pattern at this time is WU phase energization, the U phase upper arm element 411 and the W phase upper arm element 413 are turned on. Furthermore, since the energization pattern at time t23, which is the next calculation timing, is WV phase energization, the V phase upper arm element 412 and the W phase upper arm element 413 are turned on.

As described above, the shift range control device 40 of the present embodiment switches the shift range by controlling the drive of the motor 10 having the motor winding 11, and includes the drive circuit 41 and the ECU 50 which is a control unit.

The drive circuit 41 has switching elements 411 to 416 provided corresponding to each phase of the motor winding. The ECU 50 drives the motor 10 by controlling the on/off operation of the switching elements 411 to 416, and stops the motor 10 at a target stop position according to the target shift range. Specifically, the motor 10 is stopped so that the encoder count value θen is within the control range Rc including the target count value θcmd which is the target stop position.

The switching elements 411 to 413 connected to the high potential side are referred to as upper arm elements, and the switching elements 414 to 416 connected to the low potential side of the upper arm element are referred to as lower arm elements. In the stop control for stopping the motor 10 at the target stop position, the ECU 50 turns off all the lower arm elements, turns on a predetermined number of upper arm elements, and returns a current between the motor winding 11 and the drive circuit 41.

By refluxing the current between the motor winding 11 and the drive circuit 41, the current is reduced and the kinetic energy of the motor 10 is consumed. Therefore, the motor 10 can be stopped accurately at the target stop position. Further, since the power of the battery 45 is not used in the stop control, the power consumption related to the range switching can be reduced.

In the stop control, the ECU 50 switches the upper arm element to be turned on in response to a signal from the encoder 13 that detects the rotation angle of the motor 10. As a result, the motor 10 can be stopped more appropriately.

After starting the stop control, the ECU 50 turns off all the switching elements 411 to 416 when the rotation speed N of the motor 10 becomes equal to or less than the rotation speed determination threshold value Nth. As a result, overshoot and undershoot after the end of stop control can be prevented.

The motor winding 11 is a three-phase winding, and in the stop control two upper arm elements are turn on. Further, one ends of the U phase coil 111, the V phase coil 112, and the W phase coil 113, which are the phase windings constituting the motor winding 11, are connected by the connection portion 115. As a result, the current can be appropriately refluxed.

The motor 10 has the stator 101 around which the motor winding 11 is wound, and the rotor 105 that rotates by energizing the motor winding 11. The rotor 105 has the magnet. Since the rotor 105 has a magnet, even if the rotor 105 vibrates during the stop control due to the influence of cogging torque, the current can be refluxed in the stop control. Therefore, the vibration can be damped and the motor 10 can be appropriately stopped at the target stop position.

### Second Embodiment

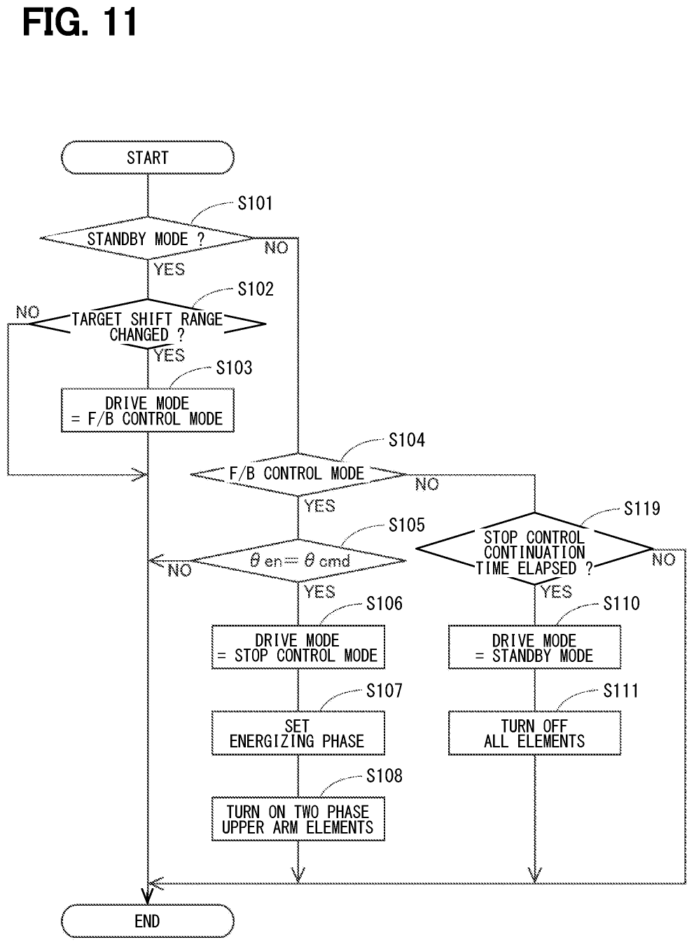

A second embodiment is shown in FIG. 11. In the present embodiment, since the motor drive control process is different from that in the above embodiment, the motor drive control process will be mainly described. The motor drive control process of the present embodiment will be described with reference to the flowchart of FIG. 11. FIG. 11 differs from FIG. 9 in that S119 is a substitute for S109. Further, when the drive mode becomes the stop control mode in S106, the time counting from the start of the stop control is started.

In S119, which is shifted when a negative determination is made in S104, that is, when the motor drive mode is the stop control mode, the drive control unit 55 determines whether or not the stop control continuation time has elapsed since the stop control was started. When it is determined that the stop control continuation time has not elapsed (S119: NO), the process after S110 is not performed, the stop control mode is continued and this routine is terminated.

When it is determined that the stop control continuation time has elapsed (S109: YES), the process proceeds to S110. The stop control continuation time is set according to the time required to consume the motor current to the extent that the rotor 105 can be stopped within the control range Rc when all the switching elements 411 to 416 are turned off.

In the present embodiment, the ECU 50 turns off all the switching elements 411 to 416 when the stop control continuation time elapses after starting the stop control. As a result, overshoot and undershoot after the end of stop control can be prevented. Thus, effects similarly to those of the embodiments described above will be produced.

### Other Embodiments

In the above embodiment, the two phase upper arm elements are turned on in the stop control. In other embodiments, the three phase upper arm elements may be turned on. In the above embodiment, in the stop control, the energizing phase is switched according to the encoder count value. In another embodiment, in the stop control, the energizing phase may not be switched, and the on state of the element that was turned on at the start of the stop control may be continued until the end of the stop control. Further, the motor control method before starting the stop control is not limited to the feedback control.

In another embodiment, the circuit configuration and the number of energizing phases may be different from those in the above embodiment as long as the current can be refluxed between the drive circuit and the motor winding. Further, in the above embodiment, one set of motor winding and drive circuit is provided. In other embodiments, a plurality of sets of motor windings and drive circuits may be provided.

In the above embodiment, the motor rotation angle sensor that detects the rotation angle of the motor is the three-phase encoder. In another embodiment, the motor rotation angle sensor may be a two-phase encoder, or may be not limited to an encoder, and a resolver or the like may be used. In the present embodiment, the potentiometer was illustrated as an output shaft sensor. In other embodiments, the output shaft sensor may be something other than a potentiometer. Further, the output shaft sensor may be omitted.

According to the embodiments described above, the two recess are formed in the detent plate. In another embodiment, the number of recesses is not limited to two, and for example, a recess may be provided for each range. The shift range switching mechanism and the parking lock mechanism or the like may be different from those in the embodiments described above.

In the above embodiments, the decelerator is placed between the motor shaft and the output shaft. Although the details of the decelerator are not described in the embodiments described above, it may be configured by using, for example, a cycloid gear, a planetary gear, a spur gear that transmits torque from a reduction mechanism substantially coaxial with the motor shaft to a drive shaft, or any combination of these gears. As another embodiment, the speed reducer between the motor shaft and the output shaft may be omitted, or a mechanism other than the speed reducer may be provided. The present disclosure is not limited to the embodiment described above but various modifications may be made within the scope of the present disclosure.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been described in accordance with embodiments. However, the present disclosure is not limited to this embodiment and structure. This disclosure also encompasses various modifications and variations within the scope of equivalents. Furthermore, various combination and formation, and other combination and formation including one, more than one or less than one element may be made in the present disclosure.

What is claimed is:

1. A shift range control device for switching a shift range by controlling driving of a motor including a motor winding, the shift range control device comprising:
a drive circuit having switching elements provided corresponding to each phase of the motor winding; and
a controller configured to drive the motor by controlling an on/off operation of the switching elements and stop the motor at a target stop position according to a target shift range,
wherein
the switching elements connected to a high potential side are referred to as upper arm elements, and the switching elements connected to a low potential side of the upper arm element are referred to as lower arm elements, and
in a stop control for stopping the motor at the target stop position, the controller turns off all the lower arm elements, and turns on a predetermined number of upper arm elements so as to reflux a current between the motor winding and the drive circuit.

2. The shift range control device according to claim 1, wherein
in the stop control, the controller switches the upper arm element to be turned on in response to a signal from a motor rotation angle sensor that detects a rotation angle of the motor.

3. The shift range control device according to claim 1, wherein
after starting the stop control, the controller turns off all the switching elements when the rotation speed of the motor becomes equal to or less than a rotation speed determination threshold value.

4. The shift range control device according to claim 1, wherein
the controller turns off all the switching elements when the stop control continuation time elapses after starting the stop control.

5. The shift range control device according to claim 1, wherein
the motor winding is a three-phase winding, and in the stop control two upper arm elements are turn on.

6. The shift range control device according to claim 1, wherein
one end of each phase winding constituting the motor winding is connected by a connection portion.

7. The shift range control device according to claim 1, wherein
the motor has a stator around which the motor winding is wound, and a rotor that is rotated by energizing the motor winding, and
the rotor has a magnet.
